(19) United States
(12) Patent Application Publication
(10) Pub. No.: US 2022/0410992 A1
(43) Pub. Date: Dec. 29, 2022

(54) Shape-Adaptive Robot For Off-Road High-Speed Applications

(71) Applicant: THE REGENTS OF THE UNIVERSITY OF MICHIGAN, Ann Arbor, MI (US)

(72) Inventors: Brian MASON, Ann Arbor, MI (US); Katharina GRENN, Ann Arbor, MI (US); Cristian ADAM, Ann Arbor, MI (US); Sridhar LAKSHMANAN, Belleville, MI (US)

(21) Appl. No.: 17/846,329

(22) Filed: Jun. 22, 2022

Related U.S. Application Data
(60) Provisional application No. 63/213,999, filed on Jun. 23, 2021.

(51) Int. Cl. B62D 61/06

(52) U.S. Cl. CPC B62D 61/065

(57) ABSTRACT

A μSMET platform system for ferrying supplies to soldiers in combat, evacuating the wounded, and helping transport loads. The μSMET platform system can adjust its geometry to suit specific payloads and adapt to the terrain, is light enough to be carried by a soldier and sturdy enough to evacuate a soldier, and has adequate off-road mobility to follow an infantry unit. The μSMET platform system's variable geometry enhances mobility over challenging terrain: its rear wheel assembly can expand to increase its stability or contract to reduce its profile.

### CROSS-REFERENCE TO RELATED APPLICATIONS

This application claims the benefit of U.S. Provisional Application No. 63/213,999, filed on Jun. 23, 2021. The entire disclosure of the above application is incorporated herein by reference.

### FIELD

The present disclosure relates to a shape-adaptive robot for off-road high-speed applications.

### BACKGROUND AND SUMMARY

This section provides background information related to the present disclosure which is not necessarily prior art. This section provides a general summary of the disclosure, and is not a comprehensive disclosure of all its full scope or all of its features.

Early efforts at developing robotic ground systems for the US Army focused on lightweight, compact robots that could investigate areas too dangerous to send people (see FIG. 1A). Portable robots such as the iRobot PackBot family carried cameras that could transmit images to an operator's controller. Simultaneously, a small robotic arm attachment could allow users to investigate suspected explosive devices or other threats. These small robots were not well suited to carry heavy payloads, travel at high speed, and were not capable of autonomous operation. Therefore, their primary use was to assist bomb disposal teams and search and rescue teams working in unstable or collapsed structures. The PackBot's modular design made it an excellent platform for specialized variants, including robots for detecting chemical and radiological warfare agents, in addition to having the functionality to detect enemy sniper fire using sensitive microphone arrays.

More recent developments focused on developing “robotic mules” for the Army to carry large numbers of backpacks and supply crates for soldiers, such as the HDT Hunter Wolf (see FIG. 1B). These robots are comparable in size to a small car and can weigh over a ton fully loaded, so they cannot remain practically concealed during operations near enemy forces. These robotic mules' size and limited engine power severely limit their speed and maneuverability, exacerbating their vulnerability to enemy fire following detection.

Experimentation with walking robotic mules, such as the Boston Dynamics AlphaDog (see FIG. 1C), has also been deemed unsatisfactory due to their low speed, lack of operational range and energy efficiency, and excessive acoustic signature in operation. Thus, the category of a compact, lightweight, inconspicuous cargo-carrying robot, which reliably resupplies troops in an active combat zone, is currently not fulfilled by available designs.

Thus, available designs are limited to the current small multipurpose equipment transport (SMET) configurations. Tests have shown, on multiple occasions, that SMET has problems in situations with off-road environments that are too narrow to allow passage of its 5 ft. wide-body, terrain with even a gentle slope that can cause it to roll-over, and urban environments where their top speed of 8 miles/hour is too limiting.

To address these disadvantages in the prior art, the present teachings provide a micro SMET (μSMET) solution. It has become clear to the inventors of the present teachings, that there is a gap in the military mobility space for an agile, small, and quiet (robotic) vehicle to accompany and assist soldiers between assembly areas and rally points, ensuring reliable last-minute delivery. According to the present teachings, as seen in FIG. 2, the supplemental nature of μSMET comes into play in the transition from “friendly” to “hostile” terrain with the ever-increasing chance of enemy contact. The smaller platform is designed to carry lesser payloads and navigate a more challenging terrain ensuring success across the last 100 meters, for example, of the battlefield.

In overcoming the current limitations that SMET currently possesses, μSMET of the present teachings seeks to expand its operating terrain through unique platform implantation based on a bicycle to a tricycle shape factor transition. The present platform would strive to improve maneuverability in narrow spaces by having the ability to contract after delivering a payload and expanding to enhance transportability. Overall, advantages of μSMET platform system 10 are given through its inherently smaller compact size. They are not intended as pack mules but rather to supplement. In some embodiments, the platform is intended to be small enough to hold a rucksack, ammunition, or solider, but not be excessively laden with gear. The reduced platform weight and increased carrying capacity lend themselves to the ability to have a higher speed than the current less than 8 miles/hour, while this platform aims to traverse at 15 miles/hour.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C illustrate conventional robot systems, including an iRobot PackBot, a HDT Hunter Wolf, and a Boston Dynamics AlphaDog, respectively.

FIG. 2 illustrates a SMET and μSMET operational envelopes according to the principles of the present teachings.

FIG. 3 illustrates a μSMET preliminary concept design.

FIG. 4 illustrates a DTV shredder personal tracked vehicle in medevac role.

FIGS. 5A-5C illustrate folding mechanism configurations including a fan concept, a scorpion concept, and a hammock concept, respectively.

FIGS. 6A-6F illustrate proposed μSMET applications including moving cover, resupply, injury exfil, single transport, high speed retreat, and bushwhacking and clearing, respectively.

FIG. 7 illustrates a μSMET platform overview.

FIG. 8 illustrates a front steering assembly.

FIG. 9 illustrates a variable geometry driven by motors and dual linear actuators.

FIG. 10 illustrates a splits mechanism.

FIG. 11 illustrates a rear wheel assembly with suspension.

FIGS. 12-12B illustrate a comparison of tilt stability profiles for the narrow and expanded μSMET configurations, respectively.

FIGS. 13A-13B illustrate a comparison of unloaded and loaded stability of the expanded configuration, respectively.

FIG. 14 illustrates an effective side tilt experienced during turning maneuvers.

FIG. 15 illustrates a minimum required turn radius for safe turning maneuvers.

FIG. 16 illustrates a yaw/pitch/roll data for steering control.

FIG. 17 illustrates a control system map.

FIG. 18 illustrates an army ranger using the Nett warrior system.

FIG. 19 illustrates a controller concept.

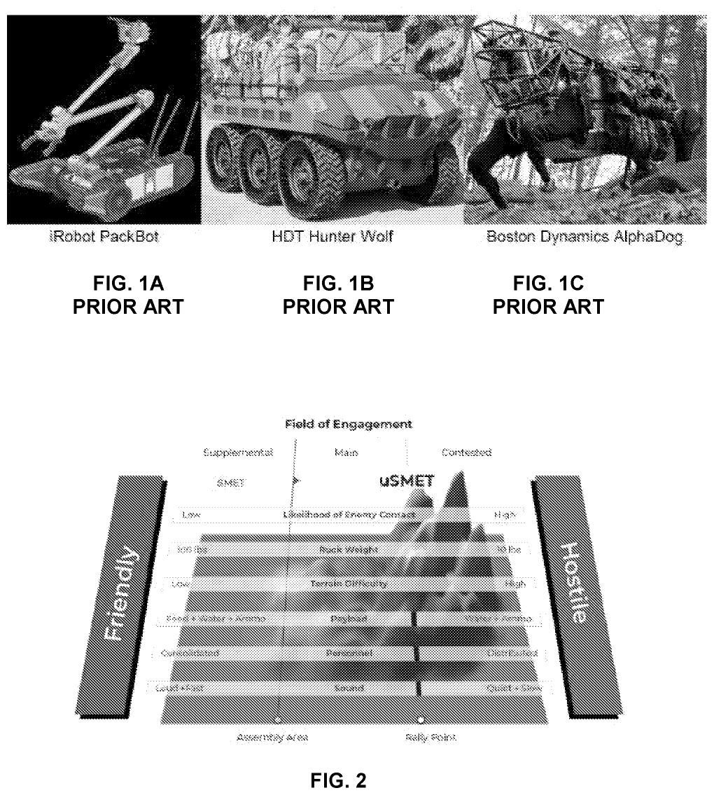

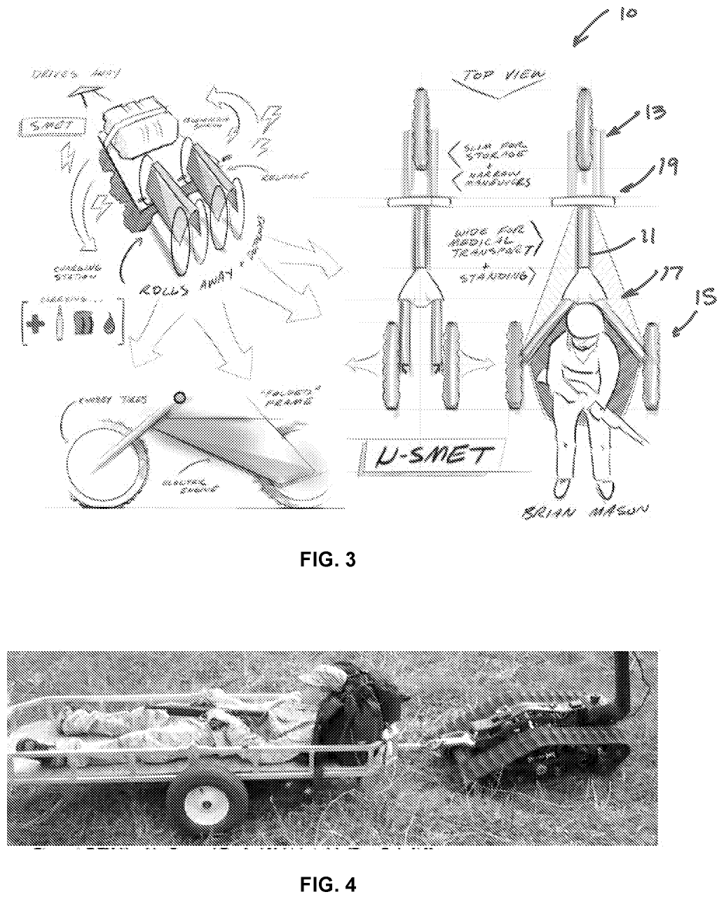

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Modern robotic technologies enable the development of semiautonomous ground robots capable of supporting military field operations. Particular attention has been devoted to the robotic mule concept, which aids soldiers in transporting loads over rugged terrain. While existing mule concepts are promising, current configurations are rated for payloads exceeding 1000 lbs., placing them in the size and weight class of small cars and ATVs. These large robots are conspicuous by nature and may not successfully carry out infantry resupply missions in an active combat zone. Conversations with active soldiers, veterans, and military engineers have spotlighted a need for a compact, lightweight, and low-cost robotic mule. This platform would ensure reliable last-mile delivery of critical supplies to predetermined rally points. We present a design for such a compact robotic mule, μSMET platform system. The present teaching envisions a versatile platform, integrated with the Squad Multipurpose Equipment Transport (SMET), which will ferry supplies to soldiers in combat, evacuate the wounded, and help transport loads on a forced march. μSMET platform system can adjust its geometry to suit specific payloads and adapt to the terrain, is light enough to be carried by a soldier and sturdy enough to evacuate a soldier, and has adequate off-road mobility to follow an infantry unit. μSMET platform system's variable geometry enhances mobility over challenging terrain: its rear wheel assembly can expand to increase its stability or contract to reduce its profile.

As illustrated in the figures, a shape-adaptive robot system 10 (also referred to as “μSMET platform system 10”) is provided having adjustability and variable design to result in hauling ability and the ability to collapse into a quick getaway on its return journey.

In some embodiments, the shape-adaptive robot system 10 comprises a support structure 11, a first wheel system 13 operably coupled to the support structure 11, a pair of second wheel systems 15, and a variable geometry coupling system 17 operably coupling the pair of second wheel systems 15 to the support structure 11. The variable geometry coupling system 17 movable between a narrow configuration and a wide configuration, whereby in the narrow configuration each of the pair of second wheel systems 15 is positioned adjacent to the other of the pair of second wheel systems 15 to form essentially a bicycle configuration of the robot system 10 and whereby in the wide configuration each of the pair of second wheel systems 15 is positioned in a spaced apart relationship with the other of the pair of second wheel systems 15 to form essentially a tricycle configuration of the robot system. In some embodiments, the variable geometry coupling system 17 can be configured in any position between the narrow configuration and the wide configuration.

In some embodiments, the shape-adaptive robot system 10 further comprises an active steering system 19 configured to stabilize the robot system 10 during operation.

In some embodiments, the shape-adaptive robot system 10 comprises a steering apparatus 12 operably coupled to the first wheel system 13 configured to provide steering input to the first wheel system 13. In some embodiments, the steering apparatus 12 comprises a motor system operably coupled to the first wheel system 13.

In some embodiments, the shape-adaptive robot system 10 comprises a rear powertrain system 14 operably coupled to at least one of the pair of second wheel systems 15. The rear power system 14 is configured to provide a drive power to the at least one of the pair of second wheel systems 15.

The present μSMET platform system 10 is able to fulfill several major battlefield roles. Most importantly, it can provide reliable last-mile resupply for units in a combat zone, bringing ammunition, medical kits, and other urgently needed consumables to soldiers in action, without requiring soldiers to make the dangerous journey back to their supply base under enemy fire. Since μSMET platform system 10 is a compact, high-speed platform, capable of autonomously navigating to a requested destination, it can easily travel concealed by local terrain—thus rendering itself less vulnerable to enemy fire even when traveling over open terrain with limited cover, compared to a more conventional car-sized robotic mule. Alternatively, swarms of μSMET platform systems 10 can be used to resupply artillery units with ammunition in situations where a traditional artillery resupply vehicle may be unable to navigate rugged terrain, find itself vulnerable to enemy fire, or may draw unwanted attention to a concealed artillery position. Robots returning from the combat zone, having delivered their supplies, can be used for medevac missions, evacuating individual wounded soldiers back to a secure position for immediate medical treatment. This basic concept was formerly explored with the DTV Shredder personal tracked vehicle, for instance, which can operate in robotic mode towing a man-sized cart (see FIG. 4). However, the base vehicle is not itself designed to a secured payload.

Conversely, μSMET platform system 10 can carry a soldier. It does not have to rely on being paired with additional transport devices, reducing the logistical load on units that use it for medevac missions. μSMET platform system 10 can be compatible with a wide variety of payloads, as it can easily be modified to carry standard modular mounting systems, such as Picatinny rails, as well as custom mounting bracketry for particular types of cargo, such as artillery shells. μSMET platform system 10 can be adapted to carry external attachments, including acoustic gunshot detection systems, sensors for detecting landmines and IEDs, CBRNE surveillance sensors, or infrared imaging equipment to detect approaching enemy vehicles at long range—thus serving as an effective early warning platform, informing soldiers of incoming threats, and enhancing their situational awareness on the battlefield. Suppose a fleet of μSMET platform systems 10 is equipped with portable radios; in that case, they can serve as nodes in a retransmission network, providing reliable communication for units deployed in dense urban or mountainous areas, where the complex environment limits radio communication range.

μSMET platform system 10 robot derives its inspiration from an uncomplicated bicycle, a highly efficient energy efficient transporter of payload and personnel in narrow spaces and uneven terrain. There are ample examples in history of bicycles being used by the military, especially for medical evacuation of wounded soldiers from the battlefield. There are also examples of the bicycle being used as a surrogate to a mule for transporting heavy payload—reconstituted bicycles have carried up to 1000 lbs. along forest trails.

The problem with the bicycle is that it is nominally/inherently unstable and requires a human in the loop to stabilize it, whether it be for driving it or pushing it. Drawing on a contemporary example of research conducted at the University of Michigan-Dearborn, there is the development of an active steering stabilizable unmanned bicycle. Additional studies into unmanned stabilization can be seen through the works spanning the last ten years. Those prior efforts directly lead to the concept of μSMET—a platform that inherits all the agility and versatility of a bicycle without its nominal/inherent instability. The other inspiration for μSMET platform system 10 is tricycles—an optimal transporter of heavy payloads or multiple persons in congested urban areas. The tricycle problem is that its wider wheel track has difficulty in narrow and uneven terrain when carrying a payload. Despite this limitation, there are several tricycle examples seen in military history.

The combination of a tricycle and bicycle results in the premise of μSMET. Variable geometry is the highlight of this platform in that it combines the main objectives. It has been envisioned that additional and/or alternative configurations and uses of the present principles can be provided, including but not limited to moving cover, resupply, injury exfil, single transportation, high-speed retreat, and bushwhacking and clearing ability to aid soldier movement can be seen in FIGS. 6A-6F. These are all features but not the primary purpose of the design. The ideas were narrowed down based on practicality and needed to be focused on speed, carrying ability, and agility.

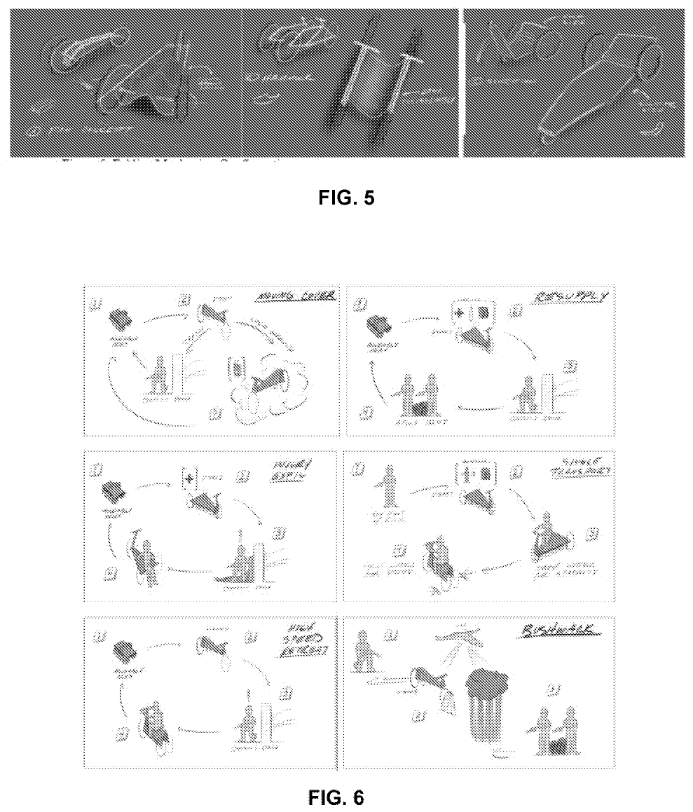

When going through the iterative design process, variations arose to meet the design criteria revolving around a bicycle-based platform. This manifested itself most heavily around the transition process in which the vehicle would expand and contract. Proposals ranged from expanding hammocks able to be lifted as a medical evacuation suspended between two individual bikes, a swinging rear fan spreading to carry a payload, and a foldable scorpion tail that would flip down to accommodate for diverse missions, as shown in FIGS. 5A-5C. The various features were weighed considering each configuration's advantages and disadvantages. Ultimately, a fan spread concept was ideal as it allowed for the most stable platform and versatile loading options that can be outfitted for diverse mission sets.

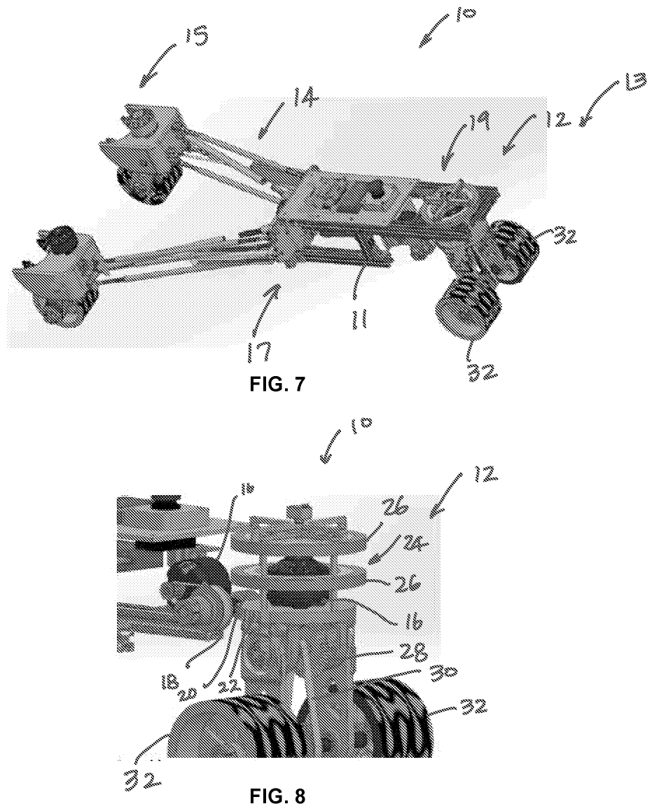

Dismounted soldiers carry anywhere between 60-120 lbs. of water, food, ammunition, battery, fuel, and other equipment in their backpacks. This heavy payload limits their mobility and ultimately leads to soldier fatigue. To counter this fatigue, μSMET platform system 10 is designed to integrate with the current SMET programs and supplement soldier movements. This supplemental nature plays into mechanical design because it is imperative to accommodate for varied loads and adapt to the environment. μSMET platform system 10, weighing in at 40 lbs, is currently built to carry a 100 lb. payload at a speed of 16 mph and pass through a 3-foot doorway with plans to exceed 100 lbs. The rear-wheel track has to articulate dynamically to balance the robot- to mechanically contract and expand its lateral distance between its rear wheelbases. Relying heavily on its crucial shape adaptive properties, the robot's narrow version will enable it to maneuver in tight spaces and travel at increased speed, and maintain high rates and dynamic stability in its expanded configuration. When μSMET platform system 10 is in its narrower shape, it is prone to roll-over, whereas it is more inherently stable when it is in the broader form. With its variable design highlight, the platform maintains dynamic stability via a combination of software and mechanical setup. The chassis is divided into two focus areas: steering apparatus 12 and rear powertrain system 14. FIG. 7 offers an overall mechanical layout. It should be understood, however, that the present teachings can be configured to have the configuration illustrated in the figures or, alternatively, can have a reversed orientation with a narrow wheel system in the rear (relative to the primary direction of travel) and the articulating wheel system in the front. It has been found that having the narrow wheel system in the rear can enable tighter turn radii whereas the narrow pair in the front can enable enhanced roll stability. Moreover, it should be understood that the disclosed teachings can be configured to be multi-directionally driven to enable benefits based on direction of travel (i.e. narrow in “rear” or narrow in “front”).

As illustrated in FIG. 8, the steering apparatus 12 contains two high-torque motors 16 independently connected to belt-driven systems 18—one motor acts to control the rotational steering through a worm gear 20 to a toothed platform 22. Designing a worm gear drive setup ensures that sufficient torque is present and prevents back-driving due to bumps from rugged terrain. The steering column 24 consists of the toothed platform 22 attached to two offset lazy susan turntables 26 constructed in double sheer to aid in turn movement. Situated on this platform 22 is the second motor 16 that translates motion into the wheelbase via gears 28 and belts 30 to drive the wheels 32. A rotational potentiometer monitors and provides active feedback to the control system to have accurate rotational position bearings.

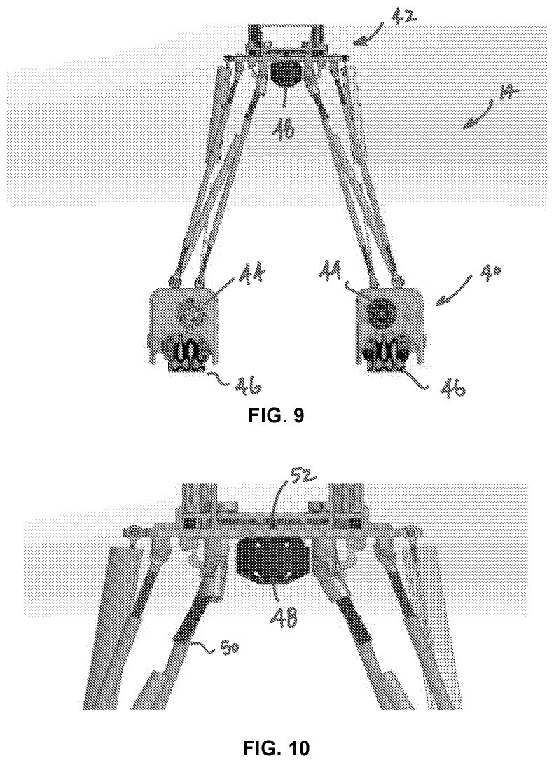

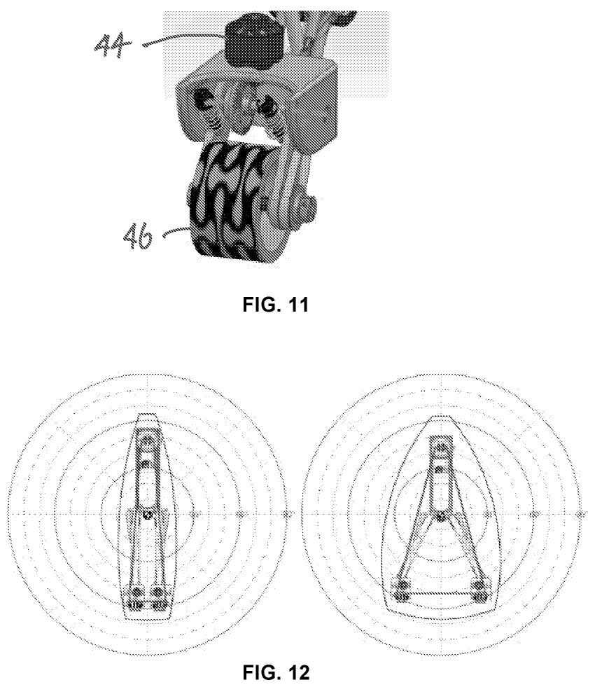

The rear powertrain system 14 consists of both the rear wheel track 40 and the splits mechanism 42 to produce the variable geometry. The rear powertrain system 14 contains three high-torque motors 44 that power wheels 46 independently to improve traction in off-road scenarios, as seen in FIG. 9. Dynamic stability is gained in design by creating the rear wheel track 40 powered by a single motor 48 mechanically linked to threaded rods 50 for actuation. This single motor 48 setup enables both rods 50 to expand outwards and contract inwards in tandem on a geared ratio via a geared drive system 52 rather than at different rates. It should be understood that this can be varied to provide a split geometry system to provide in independent variable control. Dual linear actuators monitor and provide electronic feedback to the control software to maintain the vehicle's desired position. Additionally, located within the rear powertrain system 14 are two rear wheels 46. Two separate wheels on a belt are driven systems to translate the motor's rotation into wheel torque. These rear wheel setups contain suspension shocks to allow the vehicle to handle the various terrains the vehicle may encounter.

μSMET platform system 10 was initially inspired by earlier development efforts to design and prototype an autonomous robotic bicycle. Interest in this topic has been motivated by both the inherent mobility advantages that bicycles offer over other platforms of similar weight and the increased complexity of dynamic controls required for an autonomous bicycle. Unlike conventional robotic platforms, bicycles are not statically stable, and thus, must remain in a continuous motion to avoid falling over. This constraint necessitates a quick response from a control system that perpetually gathers data about its environment and makes intelligent path planning decisions that allow the bicycle to remain stable, just like a human bicycle operator. Once developed and successfully demonstrated, however, such a control system can easily be adapted to more conventional robotic platforms, enabling them to traverse rugged terrain faster without stopping and evaluating the next maneuver. As such, in its narrow configuration, μSMET platform system 10 is intended as a testbed for dynamic bicycle control. Active balance stability control is implemented to assist with cornering forces and dynamic roll centers.

The variable geometry of μSMET platform system 10 allows it to shift from a statically unstable bicycle-like configuration to a statically stable tricycle configuration. As a technology demonstrator, this capability enables μSMET platform system 10 to demonstrate dynamic bicycle stability and transport valuable payloads. The expanding splits can be adapted to various mounting systems, such as a simple net or canvas surface to hold bulky cargo or rigid mounts like Picatinny rails for more specialized cargo. In its transport configuration, μSMET platform system 10 is able to take advantage of the inherently more excellent stability of a wide-stance tricycle carriage while also benefiting from the fast dynamic controls developed for its narrow bicycle mode to ensure safe, reliable, and speedy transport of urgently needed supplies. These advantages make μSMET platform system 10 an attractive option for last-mile autonomous delivery in active combat zones: perpetually remaining in motion and constantly maneuvering in its terrain will make μSMET platform system 10 difficult for hostile forces to detect, track, and destroy.

The tip-over stability of μSMET platform system 10 was evaluated through analysis of its support polygon in both the narrow and expanded configurations. First, we conducted a study of its tip-over angle in all tilt directions; then, the resulting plots are shown in FIGS. 12A-12B. The evaluated tip-over stability data, represented by the blue outlines, is shown in the polar coordinate system, centered on the robot's center of mass, representing the angle at which μSMET platform system 10 will tip if it is tilted downwards along that vector from the origin. Thus, in the narrow configuration, μSMET platform system 10 will tip on a slope of approximately 65 degrees if it is oriented directly downhill (upwards along the Y-axis in the plot), 68 degrees if oriented uphill, 18 degrees if it is tipped to its left or its right (along the X-axis), 24 degrees if tipped at an angle of 45 degrees off from the front, and 26 degrees if tipped at an angle of 45 degrees off from the back. In the expanded configuration, μSMET platform system 10 will tip on a slope of 64 degrees oriented downhill, 67 degrees oriented uphill, 35 degrees tipped directly left or right, 39 degrees if tipped at an angle of 45 degrees off from the front, or 54 degrees if tipped at an angle of 45 degrees off from the back, thanks to its superior stability at the wider end of its support polygon.

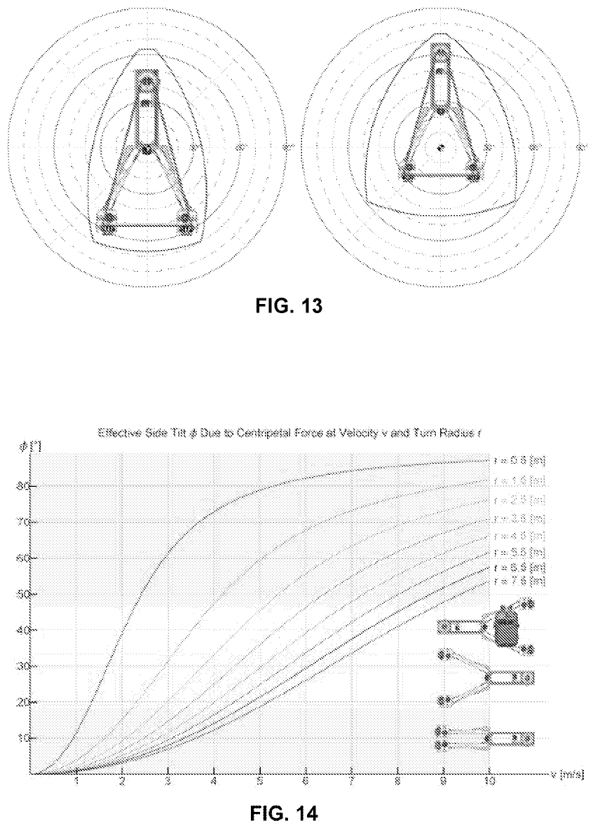

Conversely, the tip-over stability of μSMET platform system 10 can also be taken a step further and was evaluated through analysis of its support polygon in the expanded unloaded and heavily loaded conditions in which the center of mass shifts. When taking the same above principles of conducting a tip-over angle study in all directions of tilt; then, the resulting plots are shown in FIGS. 13A-13B. Thus, in the unloaded expanded configuration as mentioned previously, μSMET platform system 10 will tip on a slope of 64 degrees oriented downhill, 67 degrees oriented uphill, 35 degrees tipped directly left or right, 39 degrees if tilted at an angle of 45 degrees off from the front, or 54 degrees if tipped at an angle of 45 degrees off from the back.

When considering a heavily weighted load in the expanded configuration such as that of a large artillery shell, the center of gravity shifts significantly to the rear from the robot's center split zone. This results in an increased tilt profile. μSMET platform system 10 will then tip on a slope of 74 degrees oriented downhill, 72 degrees oriented uphill, 55 degrees tipped directly left or right, 50 degrees if tipped at an angle of 45 degrees off from the front, or 54 degrees if tilted at an angle of 45 degrees off from the back. This is important to note that this shift in points will occur when there is significant enough mass to cause a center of gravity shift, creating an even more comprehensive support polygon of stability.

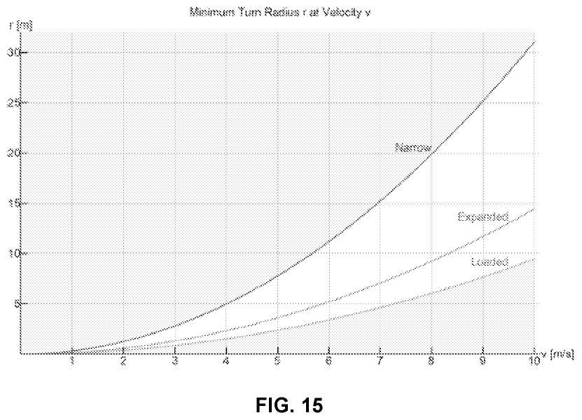

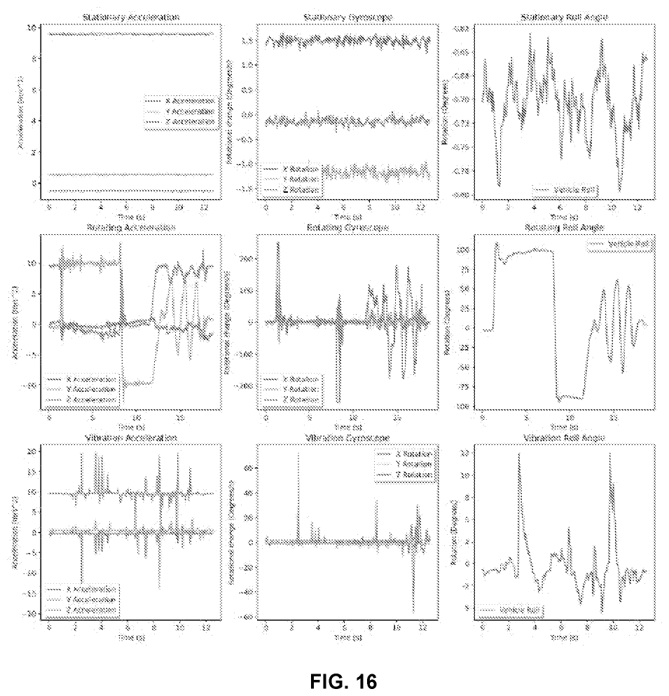

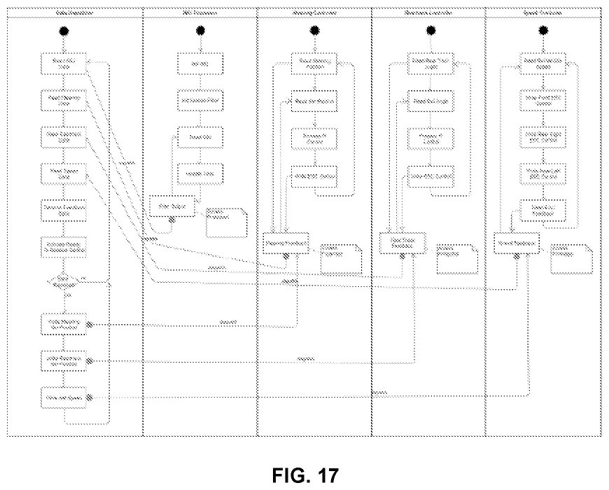

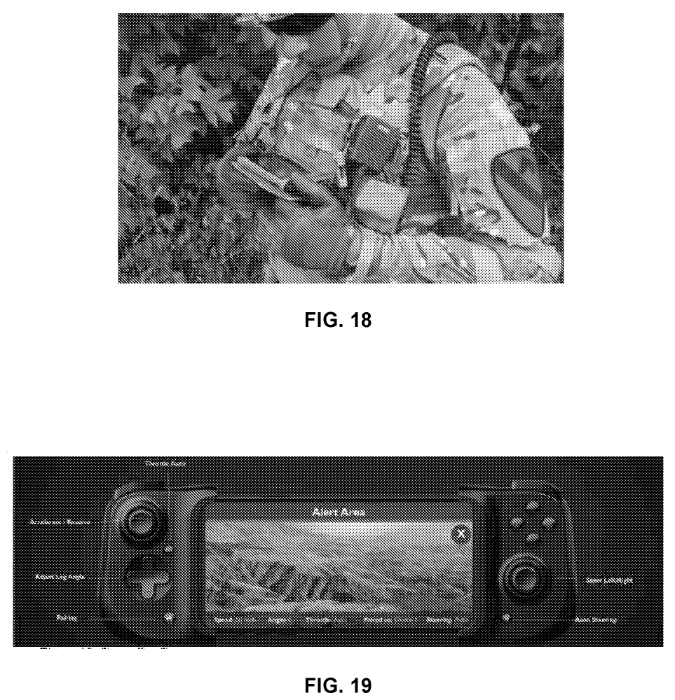

Calculated data on μSMET platform system 10's tip-over stability was then used to evaluate its stability on turning maneuvers conducted at some arbitrary velocity around an arbitrary turn radius. FIG. 14 shows the equivalent side tilt experienced by μSMET platform system 10 performing turns in a 1 g gravitational field on flat, level ground, as determined by the robot's speed, turn radius, and the corresponding centripetal force. From 0 to 18 degrees, the blue area represents turning maneuvers that are safe for μSMET platform system 10 in the narrow configuration. In contrast, from 18 to 35 degrees, the green area represents more aggressive turning maneuvers that are safe in the expanded format only. In the yellow zone, turning maneuvers are allowable from 35 to 47 degrees when having a loaded chassis. All turning maneuvers resulting in an experienced side tilt over degrees are expected to result in μSMET platform system 10 attempting to tip over. However, the robot can likely recover from moderate tip-over events in the expanded configuration. The data presented in FIG. 14 is condensed and summarized in FIG. 15, representing the minimum required turning radius for μSMET platform system 10 attempting to conduct a turning maneuver on flat, level ground at an arbitrary velocity. The resultant curves follow a quadratic function. The minimum required turn radius in the narrow configuration roughly twice the magnitude of the turn radius in the expanded configuration, as expected from the known side slope tip-over angles. Turns attempted at excessively tight turn radii are expected to result in robot tip-over.

The actuation of the splits mechanism, combined with throttle and steering control, will keep the robot upright while traversing irregular terrain. An Inertial Measurement Unit (IMU) will be used to keep track of yaw, pitch, and roll movements and be used as inputs to a PID controller that will maintain the net forces within its support scope polygon adjust accordingly if it exceeds the performance envelope.

An Nvidia Jetson Nano controls this at a high level, with a Bluetooth connection to a phone control unit that will send high-level directions such as waypoint or target following or medium-level directions such as manual control of steering and throttle. Once these controls are received, they will be combined with sensor inputs from the camera, lidar, IMU, and wheel speed sensors. The aforementioned controls will then implement low-level controls such as torque vectoring for improved traction, which will process on an embedded microcontroller for faster responses to changes in low-level sensor inputs.

The following feedback will be sent to the control unit to help the operator adjust their tactics and control if necessary:

1. Video stream

2. μSMET current state information including

a. velocity/heading

b. payload/splits angle

c. GPS location

d. Battery state of charge information

3. Operation mode

a. Manual control

b. Waypoint (progress to next waypoint, obstacle status)

c. Tracking mode (distance to target, tracking confidence)

The design of μSMET platform system 10 enables the carrying of a suite of onboard sensors to enable autonomous mobility. At the most basic level, the robot's position and orientation are tracked using an onboard Inertial Measurement Unit (IMU). While IMUs are known for low fidelity over long distances and are subject to drift, they do not rely on any external systems and leave no evident signature, so they are an excellent type of baseline sensor to use in a radio-denied, GPS-denied, hostile environment. In addition to an IMU, μSMET platform system 10 is intended to carry an array of cameras to use basic computer vision to help identify obstacles, decide on maneuvers, and gather data on potential threats in its environment.

If μSMET platform system 10 is operating in a low-risk environment, or if enemy detection is not a major concern, the robot will also be operating a low-cost LIDAR, as this type of sensor is much more effective at identifying obstacles and mapping the topology of the surroundings of μSMET platform system 10 than a simple camera array. Since LIDARs do have a significant near-IR signature when operating, which can easily be detected using basic night vision devices, μSMET platform system 10 would have to operate without a LIDAR when conducting covert operations to avoid drawing enemy attention to its origin, path, or destination.

The second round of design research was conducted to discover the best methodology and hardware with which to control μSMET. Interviews with Army personnel indicated a desire to limit additional heavy equipment and that infantry soldiers were already starting to carry mobile devices, ranging in size from phone to tablet, in pouches on their plate carriers.

As such, the controller we chose was a collapsible gaming controller that uses a USB-C connection to attach to an Android smartphone. Hard controls (rather than on-screen) are essential for steering a vehicle in the field, while the camera can act primarily as a camera feed with status messages regarding vehicle status. This allows the soldier to use a familiar mental model to control μSMET platform system 10 while keeping costs down.

Going forward, mechanically, μSMET platform system 10 would aim to convert to a carbon fiber chassis from the prototype 80/20 stock aluminum that is currently implemented for the mainframe. This would allow both weight savings and more flexible design base to aid with rollovers. In addition to the chassis material change, the rear powertrain system 14 would change to include individual leg moments. Currently, the legs expand and contract in unison on a set motored gear ratio. To separate the leg movements allowing for independent articulation would result in enhanced cornering abilities. This can be used in both the expanded and contracted forms of the vehicle. Experimentation would be needed to accurately track the polygon of support to interact with the control algorithms. In addition to enhanced cornering ability, independent arm articulation can be used when traversing uneven terrain to enhance the vehicle dynamics when taking into account topological terrain mapping and lidar interaction.

Additionally, there is limited suspension currently included in the prototype. The suspension is limited mechanically to shocks in the rear wheel track mounted on each strut. Electronic suspension is to be integrated into both the front suspension and rear powertrain system 14 to aid in vehicle dynamics and payload protection. The electronic suspension would use a computer-controlled system that can adjust the overall vehicle's ride characteristics and performance. Unlike the current suspension system, an electronic suspension would modify the shocks and struts electronically to ensure a smooth ride in addition to adapting to changing road conditions for improved handling in all sorts of terrain.

One major area of further development for μSMET platform system 10 is the implementation of more advanced autonomous navigation capabilities. Fully autonomous navigation to the desired destination would require integrating an onboard GPS system, as it is currently the best option for vehicle positioning in areas where auxiliary positioning systems, such as cell tower triangulation or tower-augmented GPS are not available. μSMET platform system 10 equipped with a GPS tracker can be provided a GPS destination to arrive at a series of GPS breadcrumbs to follow a specific path used earlier by another vehicle or person. GPS enabled μSMET platform systems 10 can also make use of geofencing—the commanding unit may define a geographical area as a no-go zone—due to the presence of hostile forces or passive threats like landmines, and μSMET platform system 10 would therefore find routes to its destination, avoiding the geofenced kill zone. GPS trackers on a fleet of μSMET platform systems 10 equipped with various threat sensors, such as gunshot locators or chemical agent sensors, as discussed in the introduction, would provide commanders real-time awareness of peripheral threats as they evolve on the virtual map and allow units to react before being ambushed by an unexpected attack.

If μSMET platform systems 10 are to be used in conjunction with other vehicles or soldiers, developing a leader-follower capability would significantly enhance the robots' utility to the Army. The forward-facing camera system can be trained on a standard fiducial marker, such as a QR code, so that μSMET platform system 10 autonomously follows a leader vehicle or person, maintaining a fixed distance throughout the journey. This would reduce the need for soldiers to manually operate μSMET platform system 10, allowing them to focus on their environment and be alerted to approaching threats. Autonomous following of fiducial markers can also be used to string together small caravans of μSMET platform systems 10, carrying substantial amounts of supplies to a forward position, though more advanced autonomy would be required to avoid fishtailing at the back of the caravan.

Since μSMET platform system 10 is designed to be a lightweight, low-cost platform, fleets of these robots can be deployed to explore and map out potentially hazardous areas of interest, such as tunnels, caves, partially collapsed buildings, and other dense urban warfare zones that can either be used by militants as secure bases or can be the destinations of lifesaving search-and-rescue operations. While a single μSMET would have limited radio communication in such environments, a fleet of μSMET platform systems 10 can establish a radio network, piping the collected data up to the surface. Mapping can be conducted by a forward force of μSMET platform systems 10 equipped with low-cost LIDARs and cameras, with the supporting μSMET platform systems 10 behind this forward force used only for radio retransmission, reducing the overall amount of data flowing through the network. Real-time transmission of collected data would ensure that at least some of the information is captured and stored by the main receiving node if the mapping fleet is destroyed by enemy action or lost in a structural collapse.

While a GPS receiver would significantly expand navigation capabilities of μSMET platform system 10, the implied constraint of using such a GPS device is the combat environment itself. Operating in a zone controlled by hostile Electronic Warfare platforms, such as high-power radio jammers, or operating in rough mountainous terrain, the robot may not receive a GPS signal. It thus would rely on alternative means of localization, mapping, and route selection. However, it should be understood that use of a GPS receiver can be coupled with μSMET platform system 10 in some embodiments.

One such alternative method may involve use of IMU and camera in μSMET platform system 10. μSMET platform system 10 can follow a path pre-traveled by another platform, which would have recorded its IMU data and taken photographs of specific landmarks along the route (for instance, distinctive-looking boulders). μSMET platform system 10 can be provided this data before starting its journey and attempt to match the route extrapolated from the IMU data, correcting for drift in the IMU recording and μSMET platform system 10's own IMU drift by detecting the same landmarks using its camera feed and correcting its position estimate accordingly. If an actual thoroughfare exists along such a pre-planned route, such as a dust road or a forest footpath, which looks distinctive from its immediate surroundings, μSMET platform system 10's cameras can also help keep μSMET platform system 10 traveling along the actual path, further correcting for IMU drift.

Another method for navigating μSMET platform system 10 towards a destination in a GPS-denied environment is by using a directional radio antenna, ideally, one that is configured for an uncommon radiofrequency outside of the typical range interrupted by radio jammers. The deployed unit that needs to be resupplied can carry such a directional antenna and use it as a beacon visible to friendly forces (towards whom it is pointed) while remaining undetectable to hostile forces. μSMET platform system 10 can be equipped with a directional receiver set to the same frequency and home in on the source like an anti-radiation missile, using its onboard cameras to avoid obstacles along the way. While this system may be impractical for a small infantry squad, it can apply to concealed artillery emplacements in need of covert ammunition resupply.

With further development, μSMET platform system 10 can be adapted to more demanding roles as well. As a lightweight, low-cost platform, μSMET platform systems 10 can serve as an autonomous sentry or patrol robots, persistently circling and guarding a perimeter, and alerting friendly forces about the approach of potential threats. The low production and operation costs of μSMET platform system 10 would make it well suited for this role, as it is more economical to replace than a full-size SMET if it were to be lost in an ambush, in addition to requiring considerably less financial investment in recharging or replacing its onboard batteries after persistent long-duration patrols. The modular design of μSMET platform system 10 would allow it to easily carry a wide range of additional sensors for patrol missions, such as night-vision cameras and thermal imaging cameras for detecting approaching individuals or vehicles, sensitive acoustic sensors to detect abnormal sounds indicating potential threats, and radio spectrum analyzers for detecting enemy radio systems.

μSMET platform system 10's low cost allows for a configuration set as a semi-expendable ultralight combat platform. While the Army is extremely cautious about equipping autonomous systems with lethal weapons, μSMET platform system 10 can play a key role in diversion operations, forcing enemy troops to respond to fake simulated attacks, drawing their attention away from the actual attacking force. In this role, μSMET platform system 10 can be equipped with lightweight smoke generators and smoke grenades to obscure the diversion, and be “armed” with acoustic gunfire simulators, loudspeakers, flashbangs, and other nonlethal weapons, which can convince the enemy to direct part of its force to deal with this supposed threat. Swarms of μSMET platform systems 10 can be used to set up a single convincing diversion of a major assault operation or split up into groups to carry out several simultaneous diversions at distant locations, presenting the enemy with multiple dilemmas, overwhelming their command structure with their own conflicting reports about these simulated attacks. During nighttime diversion operations, μSMET platform systems 10 can intentionally use their LIDARs as a distraction, or even be armed with laser dazzlers, which can detect enemy electro-optical imaging systems (such as modern tank gunsights) and dazzle them with low-power laser beams which otherwise cause no permanent damage. The goal of μSMET platform system 10 in these diversion operations is to distract the enemy long enough for the friendly attacking force to begin their own attack, after which the diversionary μSMET platform systems 10 can return to a safe staging area. However, since many μSMET platform systems 10 may be lost to enemy fire in these operations, the baseline platform's low cost makes it well-suited for such semi-expendable roles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shape-adaptive robot system comprising:
a support structure;
a first wheel system operably coupled to the support structure;
a pair of second wheel systems; and
a variable geometry coupling system operably coupling the pair of second wheel systems to the support structure, the variable geometry coupling system movable between a narrow configuration and a wide configuration, whereby in the narrow configuration each of the pair of second wheel systems is positioned adjacent to the other of the pair of second wheel systems to form essentially a bicycle configuration of the robot system, whereby in the wide configuration each of the pair of second wheel systems is positioned in a spaced apart relationship with the other of the pair of second wheel systems to form essentially a tricycle configuration of the robot system.

2. The shape-adaptive robot system according to claim 1 further comprising:
an active steering system configured to stabilize the robot system during operation.

3. The shape-adaptive robot system according to claim 1, wherein the variable geometry coupling system can be configured in any position between the narrow configuration and the wide configuration.

4. The shape-adaptive robot system according to claim 1 further comprising:
a steering apparatus operably coupled to the first wheel system configured to provide steering input to the first wheel system.

5. The shape-adaptive robot system according to claim 4 wherein the steering apparatus comprises a motor system operably coupled to the first wheel system.

6. The shape-adaptive robot system according to claim 1 further comprising:
a rear powertrain system operably coupled to at least one of the pair of second wheel systems, the rear power system configured to provide a drive power to the at least one of the pair of second wheel systems.
